(19) United States
(12) Patent Application Publication
(10) Pub. No.: US 2013/0266241 A1
(43) Pub. Date: Oct. 10, 2013

(54) COMPUTATIONAL IMAGING USING VARIABLE OPTICAL TRANSFER FUNCTION

(71) Applicants: Eliseo Ranalli, Irvine, CA (US); Robert Saperstein, La Jolla, CA (US)

(72) Inventors: Eliseo Ranalli, Irvine, CA (US); Robert Saperstein, La Jolla, CA (US)

(21) Appl. No.: 13/385,603

(22) Filed: Jun. 11, 2012

Related U.S. Application Data
(60) Provisional application No. 61/577,336, filed on Dec. 19, 2011.

(51) Int. Cl. G06T 3/40

(52) U.S. Cl. CPC G06T 3/40
USPC 382/280; 382/276

(57) ABSTRACT

In selected embodiments, improved image restoration is realized using extensions of Wiener filtering combined with multiple image captures acquired after simple, fast reconfigurations of an optical imaging system. These reconfigurations yield unique (distinct) OTF responses for each capture. The optical imaging system may reduce fabrication cost, power consumption, and/or system weight/volume by correcting significant optical aberrations. The system may be configured to perform independent correction of fields within the total field of regard. The system may also be configured to perform independent correction of different spectral bands.

### CROSS-REFERENCE TO RELATED APPLICATION

The present application claims priority from U.S. Provisional Patent Application Ser. No. 61/577,336, entitled COMPUTATIONAL IMAGING USING A CONFIGURABLE OPTICAL COMPONENT filed on 19 Dec. 2011.

### FIELD OF THE INVENTION

This document is related to the field of imaging and image processing, and particularly to computational picture reconstruction or enhancement based on a series of detected images.

### BACKGROUND

Traditionally, the “speed” of an optical design is dictated by the aberrations that can be tolerated for a given complexity of the optical design. Aberrations reduce the image forming capacity of optical systems. Known optical design may avoid or reduce aberrations by sacrificing size, cost, and/or light collection performance. Computational imaging (CI) techniques may be used to circumvent the traditional design limitations through aberration compensation performed in signal post-processing. To restore image quality, CI techniques exploit knowledge of the optical transfer function (OTF) to create filters that compensate for aberrations.

Wiener filtering uses the known optical transfer function and noise statistics to produce a linear transfer function which, when multiplied by the OTF, reduces the error in the resulting product. While it may be optimal in the sense of producing the least square error (LSE), Wiener filtering and other CI techniques are fundamentally limited in their correction ability by the optical information lost in the imaging system (i.e., between an object and a corrupted image of the object). Thus. CI imaging techniques are limited by the presence of zeroes (or minima below a detectable limit) in the OTF. While the magnitude of the optical transfer function (MTF) approaches zero at the cutoff frequency, the loss of additional information (i.e., the presence of MTF zeros or greatly reduced values) at much lower spatial frequencies is associated with aberrations. It is desirable to modify optical imaging systems in such a way as to preserve the MTF at sufficient level with respect to signal to noise ratio (SNR) for spatial frequencies of interest even in the presence of aberrations. Additionally, to support users requiring high-resolution wide-field-of-view (WFOV) and/or multispectral imaging, it is desirable to have independent compensation of image features (1) at any or all locations within the field of regard, and (2) in the spectral hands of interest.

Some computational imaging approaches have been developed, in which the MTF zeroes are avoided by, for example, one of the following techniques to fill in the OTF zeros and to create a depth insensitive point spread function (PSF):

(1) Focus sweeping. This is described in G. Hausler, “A method to increase the depth of focus by two step image processing,” Optical Communications, Vol. 6, p. 38 (1972).

(2) Wave-front coding, that is, introducing a phase-modulated pupil function which rills in the holes in the OTF. This technique may result in a significant penalty in the magnitude of the OTF at all spatial frequencies. Because of the reduced contrast, this technique may require a very high signal-to-noise ratio (SNR) for the received image. For additional background of this technique, see, for example, E. R. Dowsky and W. T. Cathe “Extended depth of field through wave-front coding,” Applied Optics, Vol. 34, No. 11 (1995).

(3) Spherical aberration. This technique is described, for example, in Robinson et al., U.S. Pat. No. 7,948,550.

(4) Coded diffusion, described, for example, in O. Cossairt et al., “Diffusion Coding Photography for Extended Depth of Field,” ACM Transactions on Graphics (Proceedings of SIGGRAPH, July 2010).

These CI techniques use a single compensation filter to correct the entire field of view. The techniques are limited in resolution for reasonable SNR by the large reduction in OTF magnitude (at most spatial frequencies) associated with their optical processing mechanisms. The techniques are also restricted to moderate fields of view by their assumption that the PSF is spatially invariant.

Another CI technique employs distinct optical imagers to capture unique images of the field of view. If the aberrations are unique to each imager, the zeros in their MTFs shill position in spatial frequency with respect to one another. In this way, optical information lost by one imager may still be captured by the other imager(s). A compensated image of the field may be formed from a combination of the filtered individual images, where filtering is applied to the spatial frequencies. The requirement for several distinct optical imaging systems limits the utility of this approach because of the increases in size and weight. This technique is described, in L. P. Yaroslavsky and H. J. Caulfield, “Deconvolution of multiple images of the same object,” Applied Optics, Vol. 33, p. 2157 (1994). It was also suggested that a single imager could be used. See G. Harikumar and Y. Bresler, “Exact Image Deconvolution from Multiple FIR Blurs,” IEEE Transactions on Image Processing, Vol. 8 p. 846 (1999).

Non-CI-based approaches include the use of multiple distinct imagers to view the same object, capturing different images of the field of regard, and extracting; the desired information from the redundant imagery. Such technique may require multiple focal planes and optical sub-assemblies. For additional background, see, for example, ft Brady and N. Hagen, “Multiscale Lens Design,” Optics Express, Vol. 17, No. 13 (2009).

The use of well-corrected optics is yet another technique. This is typically difficult and expensive.

A need in the art still exists for lower complexity, lower costs, lower weight, and/or smaller size and form-factor imagers than those associated with the known imaging techniques. A need in the art also exists to enable increased degrees of freedom in optical design, which may allow more light to be detected. Another need in the art is to provide field-dependent compensation in optical imagers. Still another need in the art is to provide spectral compensation in optical imagers.

### SUMMARY

Embodiments described throughout this document include optical designs that provide a reconstructed picture from a series of detected images. The detected images may be obtained using substantially the same optical hardware for each exposure, perturbed by a configurable optical component, for example. In variants, the optical design is reconfigured by as parameter adjustment of a single- or multi-parameter deformable mirror (DM); lens focus adjustment; focal plane position adjustment; aperture size adjustment; and liquid lens dioptric adjustment. If the aberrations are field-dependent, camera angle sweep and/or object motion may also provide unique OTF's for a series of image captures.

Each of the plurality of different optical arrangements corresponds to a different configuration of the optical hardware, for example, a different perturbation of the deformable mirror for other configurable optical component). Each of the different optical arrangements yields a known optical transfer function (OFF). In variants, the different optical arrangements (or some of them) do not share the precise locations of the OTF zeroes.

A high resolution image is reconstructed from the multiple images using post-processing algorithms. Correction of aberrations may be made field-dependent and/or spectrum-dependent. The algorithmic method may allow the user to enjoy (1) high resolution wide field of view imaging with field-specific compensation by making use of OTF information over all fields, and/or (2) high resolution multispectral imaging with spectrally dependent compensation making use of OTF information at spectral hands of interest.

Selected embodiments have the potential to advance significantly the state-of-the art in light, small-form-factor imagers which are optically fast and natively far from diffraction-limited. This potential is particularly attractive for night vision systems.

Some of the described embodiments do not attempt to correct the OTF per se, but simply rely on the configurable component to shuffle the positions of the OTFs zeroes. As a result, the configurable component (e.g., a deformable mirror) may be less complex than that required for the general task of OTF correction.

Some of the described embodiments include two least square error (LSE) solutions, both of which represent a sequential extension of the Wiener filter algorithm. One is the moving-average approach, in which a number M of detected images are used for each reconstruction. Another is a recursive approach, in which the reconstruction is continuously updated with every new detected image.

The described embodiments provide specific, practical hardware systems and methods to realize a sequence of unique OTFs in a single optical imager, and provide signal processing methods that extend CI to correct for aberrations in any or all field locations and in any or all spectral bands of interest.

### BRIEF DESCRIPTION OF THE DRAWINGS

FIG. 1 illustrates selected components of an imaging optical system with a configurable component;

FIG. 2 illustrates selected components of a computer system that may be connected to the optical system of FIG. 1 to capture images through the optical system and reconstruct a picture from the captured images;

FIG. 3 illustrates selected aspects of a Moving Average scheme;

FIG. 4 illustrates selected aspects al an Auto-Regressive scheme:

FIG. 5 illustrates selected features of as computational imaging system with configurable element(s);

FIG. 6 illustrates selected steps and features of a process for obtaining a plurality of images of a field of regard, to be combined into a processed image in accordance with selected principles described in this document; and

FIG. 7 illustrates selected steps and features of processing the plurality of images of the field of regard, combining them into a processed image in accordance with selected principles described in this document.

### DESCRIPTION

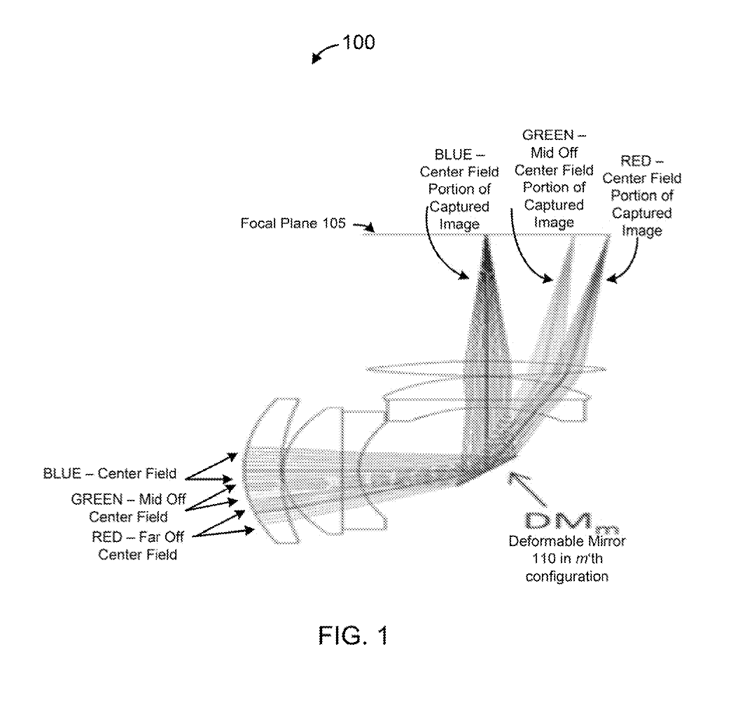

FIG. 1 illustrates selected components of an imaging optical system 100 with a configurable component. Here, the configurable component can be a simple deformable mirror (DM) 110 at the physical stop of the system 100. The deformable mirror can be configured to a plurality of different states DMₘ, m=1 . . . M, as shown in FIG. 1. Commercially available examples of NI EMS-based (microelectramechanical system-based) general purpose DMs are provided by Thorlabs, 435 Route 206, North Newton, N.J. 07860; tel. 973-579-7227; www.thorlabs.com; www.thorlabs.com/NewGroupPage9.cfm?ObjectGroup_ID=3258. Such mirrors are generally intended to take out aberrations such as defocus, astigmatism, spherical aberration and coma, often requiring many control parameters. In selected embodiments described in this document, only a single variable control parameter of the configurable optical component is used; the single variable control parameter may be the curvature of the deformable mirror. In other embodiments, two or more control parameters may be used.

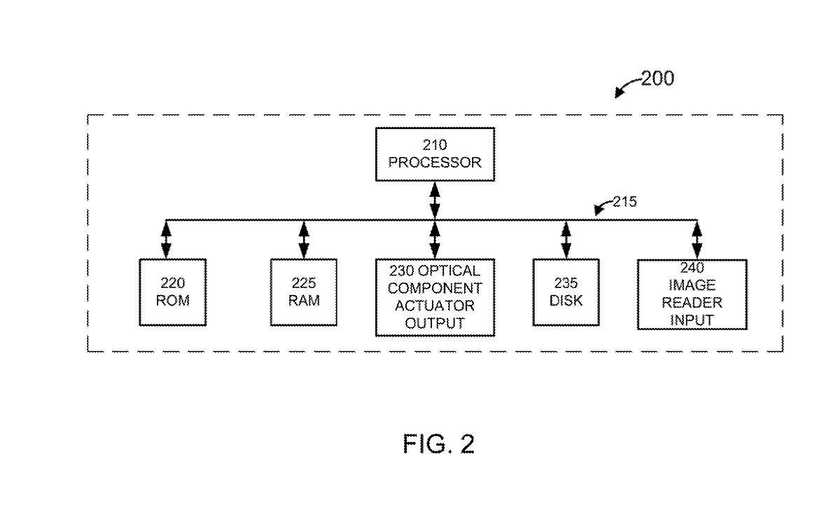

FIG. 2 illustrates selected components of a computer system 200 that may be connected to the optical system 100 to capture images through the optical system 100 and reconstruct a picture from the captured images. In particular, the computer system 200 controls the state of the deformable mirror 100 (or of another configurable optical component, or to vary the optical axis, or to provide relative motion between the imager and the object in the scene), and captures the images in the focal plane 105. The images correspond to the multiple states of the deformable mirror 110 (or to multiple states of another configurable component, or to different axes, or to different relative positions of the imager and the object in the scene). The computer system 200 then processes the captured images to construct an improved picture.

In FIG. 2, a processor 210 executes computer-readable program code instructions to control the operation of the system 200 and execute the method steps described throughout this document. The instructions may be stored in the processor 210 itself, in a read only memory (ROM) 220, random access memory (RAM) 225, and/or a disk storage 235. Generally, the program code instructions may be embodied in machine-readable storage media, such as hard drives, floppy diskettes, CD-ROMs. DVDs, and similar devices that can store the instructions permanently or temporarily, in a non-transitory manner. The program code can also be transmitted over a transmission medium, for example, over electrical wiring or cabling, through optical fiber, wirelessly, or by any other form of physical transmission. The transmission can take place over a dedicated link between telecommunication devices, or through a wide- or local-area network, such as the Internet, an intranet, extranet, or any other kind of public or private network. In one embodiment, the program code is downloaded to the system 200 through a network interface (not shown).

The computer system 200 also includes an optical component actuator output 230, controlled by the processor 210 when the processor 210 executes the program code. This can be a physical actuator or an electrical output. The actuator output 230 connects to the deformable mirror (or another configurable optical component, or to some means configured to vary the optical axis or the relative positions of the imager and the object in the scene), to put the optical imager in any one of a plurality of m states, as needed. The computer system 200 further includes an image reader input 240, configured to read the images from the focal plane 105 of the optical system 100. This may be an electrical input connected to the output of an imager of the optical system 100, or an imager itself.

A bus 215 connects the different components of the computer system 200.

As a person skilled in the art would readily understand after perusal of this document, the boundaries of some or all of the various blocks, including the systems 100 and 200, are shown for convenience of description only, and certain elements and/or functions may be logically related to multiple blocks and may be shown as belonging to more than one block.

A display device may be connected to or be a part of the computer system 200 to display the captured images, the processed picture, and/or other information.

The computer system 200 operates the optical system 100 to (re)construct a relatively high-resolution image from a sequence of in captured images; each of the captured images is acquired with the optical system 100 possessing a known optical transfer function (OTF) in its different state m. Taken individually, each of the captured images represents a substantially filtered version of the object field, with some object information irreversibly lost due to destructive interference within the optical system. With an appropriate post-detection signal processing, however, an estimate based on the image sequence can provide a relatively higher spatial resolution than that represented by any individual captured image.

The signal processing can take place in the spatial frequency domain. For each field position and configuration, there is an a-priori known filter, indicated below by coefficients Aₘ or Bₘ, which multiplies the spatial domain Fourier transform (FT) of the mth image, denoted by Iₘ. (A field position is the specific direction of incidence of the rays received by the configurable optical component, such as the deformable mirror 110; for spherically symmetrical optics, a field position may correspond to an angle of incidence, but more generally, a field position may vary in two dimensions; the concept of field position is well understood in the image processing art.)

There are several architectures (processing schemes) that can be used to process a plurality of captured images, including a Moving Average (MA) architecture, and a Recursive or Auto-Regressive (AR) architecture.

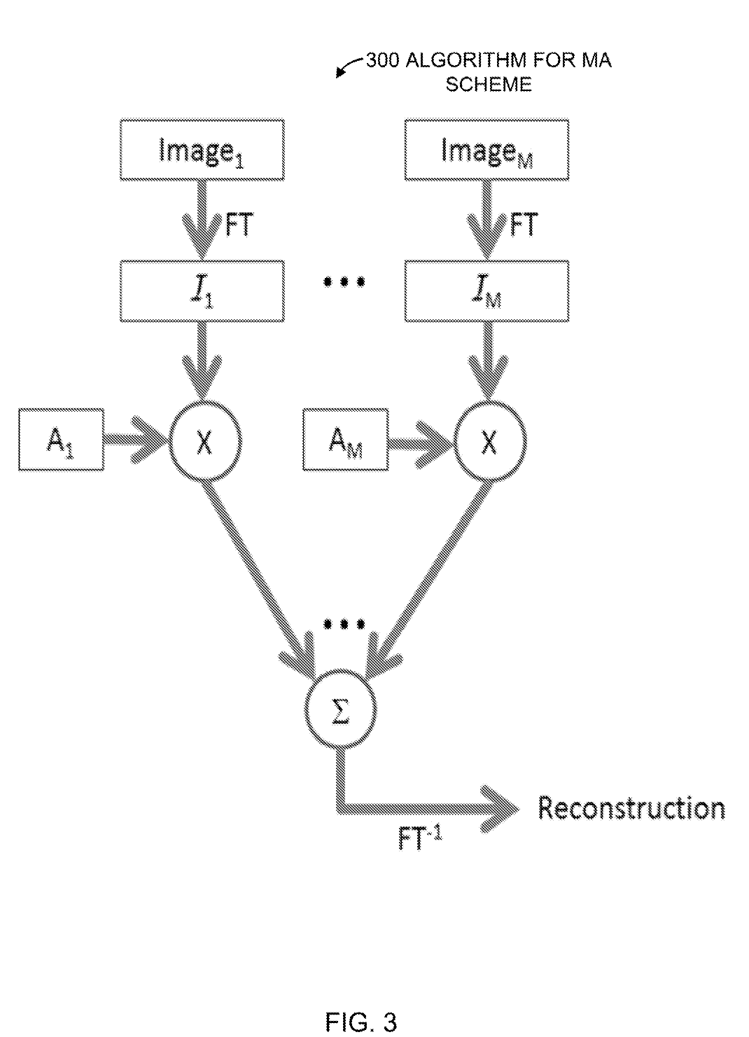

In accordance with the Moving Average scheme, M filtered FTs (Fourier transformed captured images) are summed together, and then inverse-Fourier-transformed to yield the reconstructed image with the minimum mean-square error. Selected aspects of this scheme are illustrated as a process 300 in FIG. 3.

For the Moving Average scheme, the Aₘ weighting coefficients are computed from the following formula:

$${A}_{m} = \frac{{R}_{m}^{*}}{\frac{{s}_{noise}}{{s}_{obj}} + {\sum }_{m = 1}^{M} {\vert {R}_{m} \vert}^{2}} ,$$

where Rₘ represents the complex optical transfer function of the optical system for the m'th configuration, Rₘ* is the complex conjugate of Rₘ, and S_{Noise} and S_{Obj} are the average power spectral densities of the noise and noise-free projection of the object, respectively. Each quantity expressed in the formula is spatial-frequency dependent. One or more of the zeroes of the optical transfer functions Rₘ are shifted with respect to each other as the state of the system varies. In other words, one or more of the zeroes (minima below a detectable limit) of Rₘ vary with the index subscript m. In some variant, each zero of a plurality of zeroes varies from one index subscript to the next.

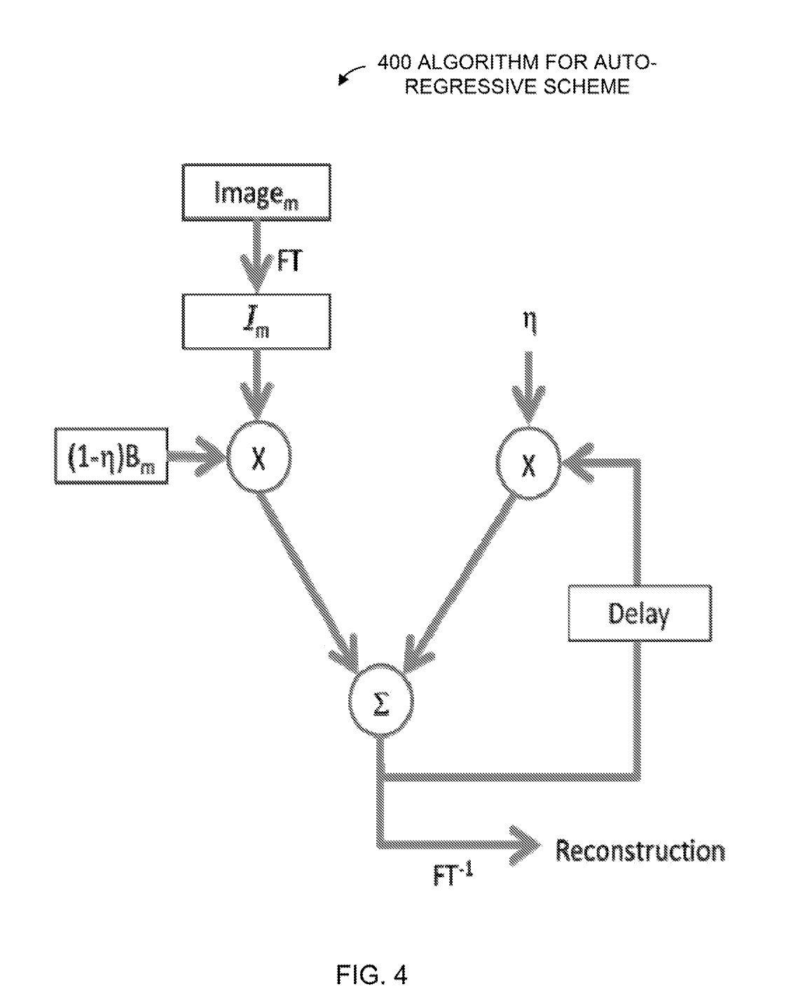

In accordance with the Auto-Regressive scheme, the Fourier Transform of the reconstructed image is continually updated with a filtered version of the last detected image, with the corresponding known OFF. Selected aspects of this scheme are illustrated as a process 40(1 in FIG. 4.

For the Auto-Regressive scheme, the Bₘ weighting coefficients are computed from the following formula:

$${B}_{m} = \frac{{R}_{m}^{*}}{\frac{{s}_{noise}}{{s}_{obj}} + {\vert {R}_{m} \vert}^{2}} ,$$

where once again Rₘ represents the complex optical transfer function of the optical system for the m'th configuration, R is the complex conjugate of Rₘ, and S_{Noise} and S_{Obj} are the average power spectral densities of the noise and noise-tree projection of the object, respectively. Each quantity expressed in the formula is spatial-frequency dependent. One or more of the zeroes of the optical transfer functions Rₘ are shifted with respect to each other as the state of the system varies. In other words, one or more of the zeroes (minima, below as detectable limit) of vary with the index subscript m. In some variant, each zero of as plurality of zeroes varies from one index subscript to the next.

Either architecture (the MA and the AR) can be made adaptive to degradations caused by various sources (e.g., atmospheric turbulence or blur caused by motion), by introducing a mechanism which instantaneously measures the point-spread-function (PSF) of the optical system, then using the resulting R (Fourier transform) coefficients in the associated equations. The PSF can be obtained using similar (guide star) techniques used in adaptive optics for astronomical telescopes. Adaptive optics works by measuring the distortions in a wavefront and compensating for them with a device that corrects those errors such as a deformable mirror or a liquid crystal array. See, for example, http://en.wikipedia.org/wiki/Adaptive_optics, and the sources cited therein, which sources include:

Beckers, J. M., Adaptive Optics for Astronomy: Principles, Performance, and Applications, Annual Review of Astronomy and Astrophysics (1993) 31 (1): 13-62. Bibcode 1993 ARA& A . . . 31 . . . 13B. doi:10.1146/annurev.aa.31.090193.000305;

Roorda, A and Williams, Retinal imaging using adaptive optics (2001), in MacRae, 8; Krueger, R; Applegate, R. A. Customized Conical Ablation: The Quest for SuperVision. SLACK, Inc. pp. 11-32. ISBN 1556426259;

Watson, Jim. Tip-Tilt Correction for Astronomical Telescopes using Adaptive Control, Wescon—Integrated Circuit Expo 1997;

Max, Claire, Introduction to Adaptive Optics and its History, American Astronomical Society 197th Meeting;

GRAAL on a Quest to Improve HAWK-I's Vision, ESO Picture of the Week as retrieved 18 Nov. 2011;

Optix Technologies Introduces AO-Based FSO Communications Product, www.adaptiveoptics.org, June 2005, as retrieved 2010-06-28:

Retinal OCT Imaging System to incorporate Adaptive Optics, www.adaptiveoptics.org, Apr. 10, 2006, as retrieved 2010-06-28; and

PixelOptics to Develop SuperVision for U.S. Military; $3.5 Million in Funding Provided ASDNews, ASDNews, as retrieved 2010-06-28.

Each of the above publications (including the Wikipedia article and the sources cited therein and listed above) is expressly incorporated by reference in its entirety, as if fully set forth herein.

The PSF may be used to post-process the captured images, rather than driving the configurable component (e.g. the DM) to create the narrowest PSF in real time.

The MA and AR techniques described above represent generalizations of the Wiener filter concept, which can be viewed as the limiting case when M=1. (Wiener or least mean square filtering is described, for example, in chapter 5 of Digital Image Processing, by Rafael Gonzalez and Richard Woods, 2^{nd} ed., 2002, which book is hereby incorporated by reference in its entirety, as if fully set forth herein.) When only a single captured image is used, the existence of zeroes in the OTF, or equivalently, in the magnitude of the OTF (which is the modulation transfer function, MTF), results in information missing from the original object, because of destructive interference within the optical system. With multiple captured images, the zeroes may move and the information missing ill one captured image may be obtained from another captured image with a different deformable mirror (or other configurable optical component) configuration with different OTF zeroes. Using the DM or other means for changing configuration, the optical system can be quickly and easily reconfigured to yield a different response, such that the region of overlap of the zeroes in the MTF for any two configurations is reduced compared to the region of the zeroes in any individual configuration. Probability of overlapping zeroes goes down with increasing M.

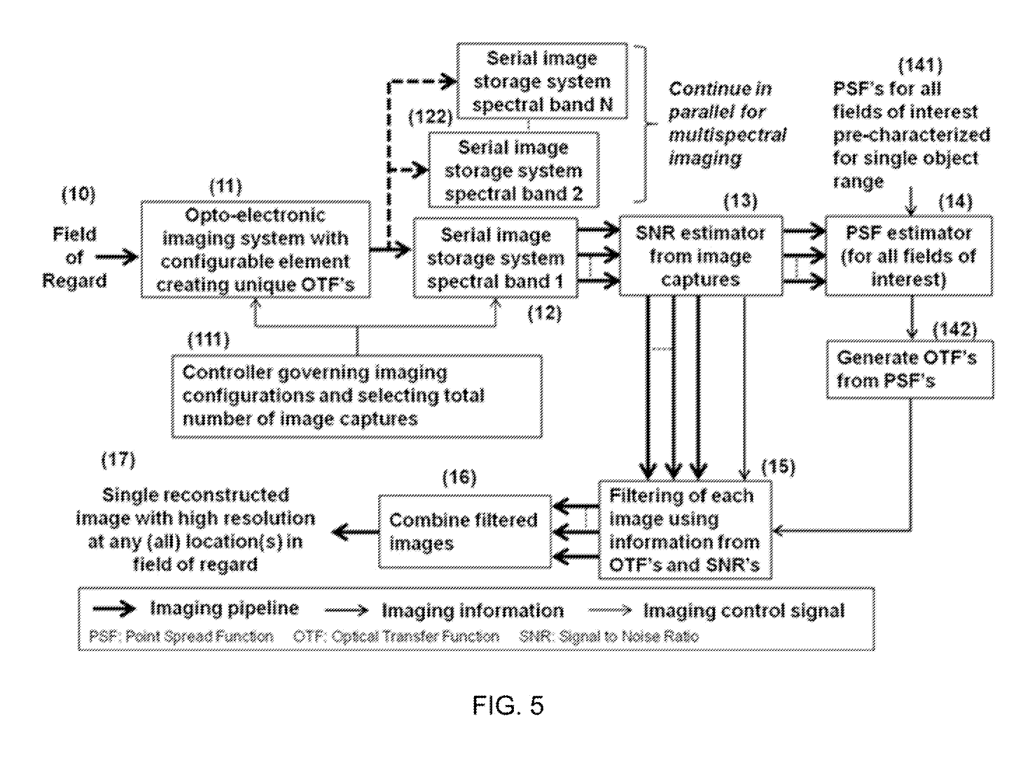

FIG. 5 illustrates selected features of exemplary embodiments of a computational imaging system with configurable element(s). Field of regard 10 is imaged by an opto-electronic imaging system 11. The imaging system 11 is configured by a computer controller 111 (such as the system 200) to a first configuration by adjusting the configurable element (or elements, as the case may be). The image is recorded in spectral band 1 and sent to an image storage system 12. If the imaging system 11 is multispectral, image storage system 12 may be extended into a plurality of image storage systems 122, isolating the images captured in each spectral hand for further processing. If desired, the computer controller 111 sets the imaging system 11 to a second configuration. This second configuration is created in such a way as to generate an optical transfer function that is different from the OTF in the first configuration. Again, the image is stored in the system 12 or in the systems 12 and 122 if multispectral imaging is being performed. The acquisition and storage process may continue in additional configurations with distinct OTFs until the number of desired image captures is achieved. Each image capture may be created using a unique setting configuration of the imaging system 11. The computational imaging process is performed on the captured images stored in the image storage system(s) 12 and/or 122. In the case of multispectral imaging, the subsequent computational processing may be performed in parallel and independently optimized by spectral band.

Because the core process may be common to all bands, the following description will continue for spectral band 1, with the understanding that identical or analogous steps may be performed for additional spectral bands. The series of stored image captures is processed in SNR estimator 13, to estimate signal-to-noise ratios (SNRs) in all or selected fields of interest within the images. To reduce processing requirements, the SNR may be predefined for each field of interest and held fixed. The point spread functions for all or selected fields of interest may be subsequently estimated in PST estimator 14 for the series of image captures. The PST estimator 14 may be seeded by field-dependent PSF's stored in a memory or other storage device 141. The field-dependent PSF's in the device 141 may be pre-characterized for the imaging configurations of the imaging system 11. If needed, the PSF's can be digitally propagated to the appropriate object range in a given field. Alternatively, scene information from the image captures can be utilized to estimate the PSF's in the PSF estimator 14. An OTF generator 142 transforms the estimated PSF's into estimates of the complex, field-dependent OTF's. The OTF's are provided to a digital filter 15. The filter 15 may also make use of the estimated SNR values. In an extension of Wiener filtering, the filter 15 may uniquely modify each image in the series of image captures using the SNR and OTF values. The filter process may be performed independently for all fields of interest. After the image series has been filtered, the images are combined in a combiner 16 to produce a single reconstructed image output 17.

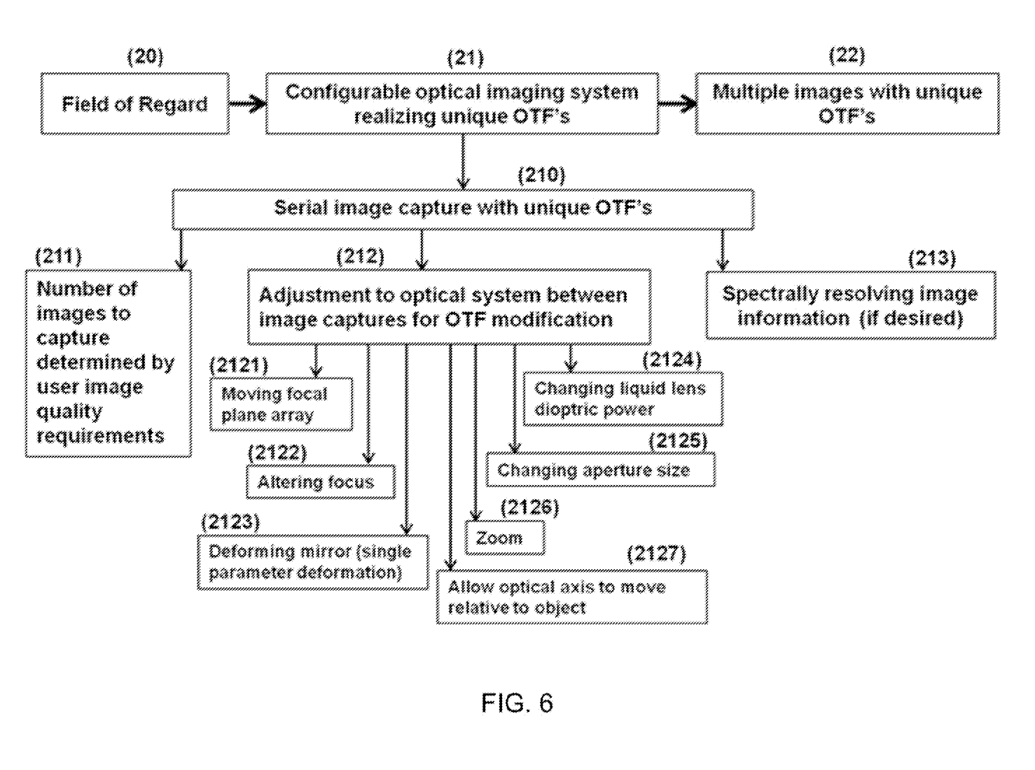

FIG. 6 illustrates selected steps and features of an exemplary process embodiment for obtaining a plurality of images of a field of regard, to be combined into a processed image in accordance with selected principles described in this document. This Figure shows one or more of the steps in progressive detail.

In step 20, an image of the field of regard is made available to the optical imaging system. For example, the optical imaging system may be deployed and pointed in a desirable direction.

In step 21, the optical imaging system captures a plurality of images. As expanded in block 210, each of the images is captured using a different distinct OTF.

Drilling down further, the system may determine (at substep 211) the number of images to be captured based on the user image quality requirements. At substep 212, the optical imaging system is adjusted from one image capture to the next, so that the OTF can change between the captured images. At substep 213, the optical imaging system spectrally resolves image information. For example, the system captures and records the image information in different spectral bands of interest, such as visible and infrared.

At the next level of detail, substeps 2121 through 2127 illustrate different ways for reconfiguring the system to realize different OTFs. In substep 2121, the focal plane array is moved, for example, by moving the optical sensor (such as CCD) relative to the optics of the optical imaging system.

As shown in substep 2122, the focus of the system may be altered, for example, by moving the optics relative to the sensor.

As shown in substep 2123, input(s) of a deformable mirror may be driven by one or more changed control parameters.

As shown in substep 2124, dioptric power of a liquid lens can be changed. Liquid lenses with variable dioptric power are generally known. A typical liquid lens may include a pair of transparent, elastic membranes, with fluid in between. The membranes may be circular and sealed together at the edges in a housing. The clear aperture of the fluid and membranes, with index of refraction greater than 1, forms a lens. Piezos control the pressure of the sealed fluid causing the membranes to deflect and become more or less convex. Changing the membranes' shapes may directly change the lens's dioptric power focal length). Liquid lenses may be available from LensVector, Inc., 2307 Leghorn Street, Mountain View, Calif. 94043, (650) 618-070, http://www.lensvector.com/overview.html.

As shown in substep 2125, the aperture size of the optical imaging system can be adjusted, for example, by controlling an iris diaphragm.

As shown in substep 2126, the zoom or magnification of a lens of the optical imaging system may be varied.

As shown in substep 2127, the optical axis of the optical imaging system may be moved, for example, by moving the optical imaging system relative to the field of regard, or waiting until an object of interest in the field of regard moves relative to the system. Movement of the optical axis relative to the object allows achieving diverse OTFs with small or no optical system reconfiguration, making use of the unique OTFs associated with each field across the imager's field of regard. Provided some relative motion between the imager and scene, the imager can capture two, three, or more images in series as the object in the scene traverses the field of regard. A given object in the scene may thus be imaged with a unique OTF at each field. The goal of imaging with diverse OTFs can be simultaneously achieved for all objects of interest. Relative motion between the scene/object and the imager can be accomplished, by object motion, imager motion, and/or imager panning (rotation). For example, the detector array such as a CCD) may be moved by a servomechanism controlled by the computer system.

Liquid crystal-based spatial light modulators may also be used for adjusting the optical system between image captures. The modulators may be obtained from various sources, for example, Meadowlark Optics, http://www.meadowlark.com/products/IcLanding.php. The liquid crystal-based spatial light modulators may be electronically adjustable, facilitating control by the computer system.

These and other reconfiguring steps may be employed individually or in combination of two or more such steps.

In step 22, the multiple images obtained in the step 21 may be stored and/or transmitted to and received by a processing portion of the system.

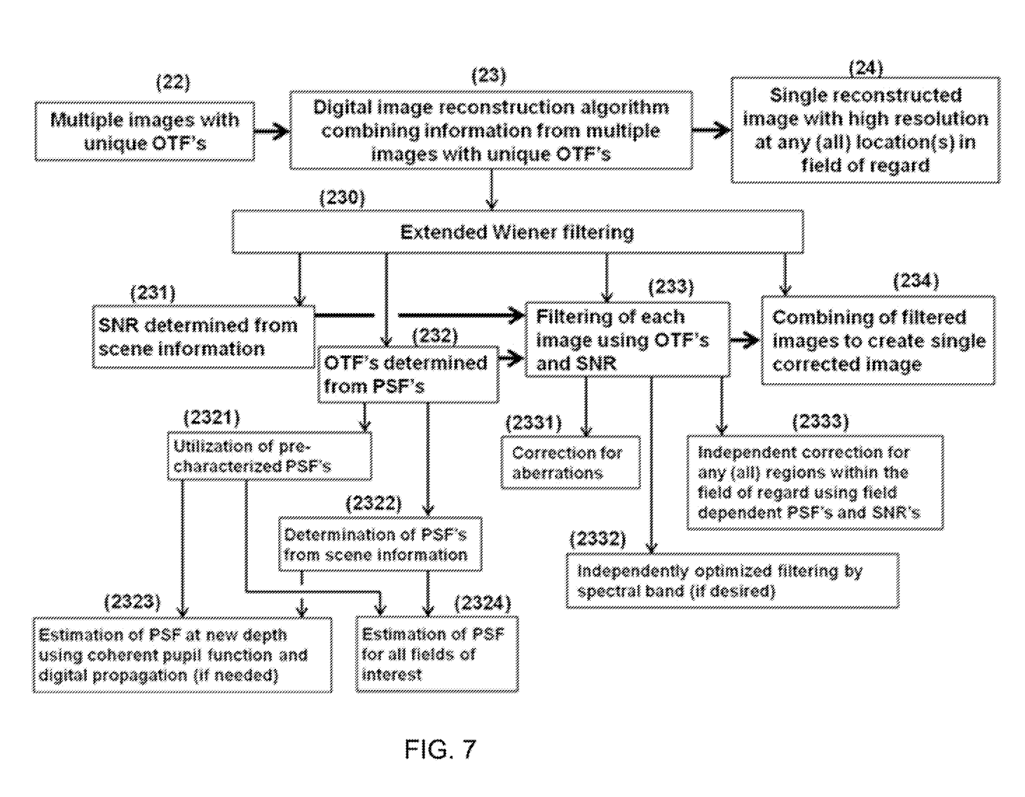

FIG. 7 illustrates selected steps and features of an exemplary process embodiment for processing the plurality of images of the field of regard, combining them into a processed image in accordance with selected principles described in this document. This Figure also shows one or more of the steps in progressive detail.

The step 22 in this Figure is also shown in the previous Figure and described in connection with the previous Figure. The multiple images may thus be received by a processing portion of the system.

In step 23, the image reconstruction algorithm combines the information from the multiple images into an improved, or reconstructed image of the field-of-view. The reconstructed image may then be stored and or outputted by the optical imaging system, in step 24.

The step 23 may include extended Wiener filtering, in substep 230 and the substeps shown under the substep 230. Some of the approaches to performing this filtering have already been illustrated in FIGS. 3 and 4, and described in connection with those Figures.

Drilling further down under the substep 230, the SNR determined in substep 231 may be the same as the Sₙₒᵢₛₑ/S_{obj} ratio shown in the formulas described in connection with the FIGS. 4 and 5. The OTFs needed for extended Wiener filtering may be obtained through Fourier transform of point spread functions, in substep 232. For example, the PSFs may be obtained in substep 2321 through pre-characterization; in other words, the imaging system may have its PSF well estimated from a characterized design and realization, or the PSF may be measured at the time of assembly or after the imager is in situ, stored in a memory or another storage device, and then retrieved when needed. As another example, the PSFs may be estimated from scene information, in substep 2322, by using known bright sources/features in a scene to be imaged. The utility of PSF's obtained for a given object distance (i.e., depth) can be extended by calculating the PSF at new object depths (substep 2323) using knowledge of the coherent pupil function and digital propagation. To support wide field of view imaging, the PSF may be pre-characterized (2321) or estimated (2322) for all fields of interest within the FOV, in substep 2324.

Continuing with details under step 23, in substep 233 each of the images may be corrected using the SNRs obtained in the substep 231 and the OTFs obtained in the substep 232. The substep 233 may include correction of aberrations (substep 2331), spectrum-based correction (substep 2332), and field-based correction (substep 2333). The knowledge of the PSFs (and OTFs) at all fields of interest is useful for the realization of image enhancement at the fields of interest, in substep 2333.

In step 24, the improved image (re)constructed in the step 23 is outputted by the system, for example, stored, displayed to a user, and/or transmitted to a local or a remote destination.

An improved or even ideal (in a least-square error sense) reconstruction of the image is enabled by (1) the use of simple configurable components that change the OTF/PSF, configurable over a plurality of M states, (2) a-priori knowledge of OTFs for the imager at a particular field/wavelength, and (3) subsequent computation using detected images, each with the optical system in the known configuration. Because of the ability of this technique to effectively till in the zeroes in the OTF normally associated with a static optical imaging system, a path is enabled toward recovering the information which may be irreversibly lost in a static optical system.

In embodiments, the recovery enables a significant reduction in size/weight/power for a given imager, because the traditional way of dealing with the presence of those MTF zeroes is to simply avoid them, often resulting in complex optical designs that are limited to a small fraction of a wavelength RMS wavefront error. In accordance with selected aspects described in this document, avoidance of MTF zeroes over a single configuration is replaced with the avoidance of zeroes over multiple configurations, which may allow the native performance of the optical imager (without the DM) to be far poorer, while still having the potential to recover high spatial resolution.

The ability of selected embodiments effectively to fill in the zeroes in the OTF (which may be associated with an aberrated static optical imaging system) preserves object information, that may otherwise be irreversibly lost in the static systems. This preserved information may enable a significant reduction in size/weight/power/cost for a given imager.

In selected embodiments, spectrally resolved image acquisition (213) combined with spectrally dependent post-processing (2332) may allow correction of the aberrations in multispectral imagers using common optical paths. The common optical path approach is advantageous for man-portable multispectral imagers, because it may reduce system size, weight, and/or cost.

In selected embodiments, the estimation of PSFs for all fields of interest (2324) and the independent aberration correction for any or all fields of interest within the field of view (2333) may allow image correction in wide FOV imagers.

Although steps and decision blocks of various methods may have been described serially in this disclosure, some of these steps and decisions may be performed by separate elements in conjunction or in parallel, asynchronously or synchronously, in a pipelined manner, or otherwise. There is no particular requirement that the steps and decisions be performed in the same order in which this description lists them and the accompanying Figures show them, except where explicitly so indicated, otherwise made clear from the context, or inherently required. It should be noted, however, that in selected examples the steps and decisions are performed in the particular progressions described in this document and/or shown in the accompanying Figures. Furthermore, not every illustrated, step and decision may be required in every system, while some steps and decisions that have not been specifically illustrated may be desirable or necessary in some embodiments.

As is known to those skilled in the art, data, instructions, signals, and symbols may be carried by voltages, currents, electromagnetic waves, other analogous means, and their combinations.

As is also known to those skilled in the art, blocks, modules, circuits, and steps described in this documents may be embodied as electronic hardware, software, firmware, or combinations of hardware, software, and firmware. Whether specific functionality is implemented as hardware, software, firmware or a combination, this description is intended to cover the functionality. Some illustrative blocks, modules, circuits, and analogous elements described in this document may be implemented with a general purpose processor, a special purpose processor (such as an application specific integrated circuit-based processor), a programmable/configurable logic device, discrete logic, other discrete electronic hardware components, or combinations of such elements. A general purpose processor may be, for example, a microcontroller or a microprocessor. A processor may also be implemented as a combination of computing devices, for example, a plurality of microprocessors, one or more microprocessors in conjunction with one or more microcontrollers and/or one or wore digital signal processors, or other analogous combination.

The instructions (machine executable code) corresponding to the method steps of this disclosure may be embodied directly in hardware, in software, in firmware, or in combinations thereof. A software module may be stored in volatile memory, flash memory. Read Only Memory (ROM), Electrically Programmable ROM (EPROM), Electrically Erasable Programmable ROM (EEPROM), hard disk, a CD-ROM, a DVD-ROM, or other form of non transitory storage medium known in the art. An exemplary storage medium is coupled to the processor such that the processor can read information from, and write information to, the storage medium. In the alternative, the storage medium may be integral to the processor.

What is claimed is:

1. An imaging method, comprising:
capturing a plurality of M captured images of an object through an optical system, the optical system comprising a configurable optical component, the configurable optical component being capable of being configured in a plurality of configurations, wherein each captured image of the plurality of images is captured with the configurable optical component being in a different corresponding configuration of the plurality of configurations;
transforming each of the captured images using a selected spatial transform to obtain a corresponding transformed captured image, whereby a plurality of M transformed captured images result;
weighting each of the transformed captured images by a weighting coefficient Aₘ computed using the formula
$${A}_{m} = \frac{{R}_{m}^{*}}{\frac{{s}_{noise}}{{s}_{obj}} + {\sum }_{m = 1}^{M} {\vert {R}_{m} \vert}^{2}} ,$$
wherein Rₘ is the optical transfer function of the optical system in configuration corresponding to the captured image from which said each of the transformed captured images was obtained, Rₘ* the complex conjugate of Rₘ, S_{Noise} is the average power spectral density of the noise projection of the object, and S_{Obj} is the average power spectral density of the noise-free projection of the object, resulting in a weighted image corresponding to said transformed captured image, whereby a plurality of M weighted images are obtained;
summing the weighted images of the plurality of M weighted images to obtain a summed transformed image; and
inverse transforming the summed transformed image using inverse transform of the selected spatial transform to obtain a processed image.

2. The imaging method of claim 1, further comprising at least one of storing the processed image and displaying the processed image.

3. The imaging method of claim 2, wherein the selected transform is a spatial Fourier Transform, and the inverse transform is an inverse Fourier Transform.

4. The imaging method of claim 3, wherein the configurable optical component is a deformable mirror.

5. The imaging method of claim 3, wherein the configurable optical component is a microelectromechanical system (MEMS) based deformable mirror.

6. The imaging method of 5, wherein the step of capturing comprises configuring the deformable mirror in the plurality of different configurations.

7. The imaging method of claim 5, wherein the step of capturing comprises configuring the deformable mirror in the plurality of different configurations using a single control parameter.

8. The imaging method of claim 5, wherein the step of capturing comprises configuring the deformable mirror in the plurality of different configurations using a plurality of control parameters.

9. The imaging method of claim 5, wherein the step of capturing comprises configuring the deformable mirror in the plurality of different configurations by varying curvature of the deformable mirror.

10. The imaging method of claim 3, wherein:
the configurable optical component is a deformable mirror;
each of the steps of capturing, transforming, weighting, summing, and inverse transforming is performed at least in part by at least one processor of at least one computer system; and
one or more zeroes of the optical transfer function of the optical system differ for at least two configurations of the plurality of configurations.

11. An imaging method, comprising:
capturing a plurality of M captured images of an object through an optical system, the optical system comprising a configurable optical component, the configurable optical component being capable of being configured in a plurality of configurations, wherein each captured image of the plurality of images is captured with the configurable optical component being in a different corresponding configuration of the plurality of configurations;
transforming each of the captured images using a selected spatial transform to obtain a corresponding transformed captured image, whereby a plurality of M transformed captured images result;
weighting each of the transformed captured images by a weighting coefficient (1−η)×Bₘ wherein η is a constant less than 1 and greater than 0, and Bₘ is computed using the formula
$${B}_{m} = \frac{{R}_{m}^{*}}{\frac{{s}_{noise}}{{s}_{obj}} + {\vert {R}_{m} \vert}^{2}} ,$$
wherein Rₘ is the optical transfer function of the optical system in configuration corresponding to the captured image from which said each of the transformed captured images was obtained, Rₘ* is the complex conjugate of Rₘ, S_{Noise} is the average power spectral density of the noise projection of the object, and S_{Obj} is the average power spectral density of the noise-free projection of the object, thereby obtaining a weighted image corresponding to said transformed captured image, resulting in a plurality of M weighted images being obtained;
initializing a summed transformed image:
after the step of initializing,
in response to obtaining each weighted image of the plurality of M weighted images, modifying the summed transformed image by first multiplying the summed transformed image by η and then adding to the summed transformed image said each weighted image; and
inverse transforming the summed transformed image using inverse transform of the selected spatial transform to obtain a processed image.

12. The imaging method of claim 11, further comprising at least one of storing the processed image and displaying the processed image.

13. The imaging method of claim 12, wherein the selected transform is a spatial Fourier Transform, and the inverse transform is an inverse Fourier Transform.

14. The imaging method of claim 13, wherein the configurable optical component is a deformable mirror.

15. The imaging method of claim 13, wherein the configurable optical component is a microelectromechanical system (MEMS) based deformable mirror.

16. The imaging method of claim 15, wherein the step of capturing comprises configuring the deformable mirror in the plurality of different configurations.

17. The imaging method of claim 15, wherein the step of capturing comprises configuring the deformable mirror in the plurality of different configurations using a single control parameter.

18. The imaging method of claim 15, wherein the step of capturing comprises configuring the deformable mirror in the plurality of different configurations using a plurality of control parameters.

19. The imaging method of claim 15, wherein the step of capturing comprises configuring the deformable mirror in the plurality of different configurations by varying curvature of the deformable mirror.

20. (canceled)

21. An apparatus for processing images, the apparatus comprising:
an optical system comprising a configurable component, the configurable optical component being capable of being configured in a plurality of different configurations; and
at least one processor, wherein the at least one processor is coupled to the optical system to enable the at least one processor to control configuration of the configurable component and to to capture images in a focal plane of the optical system, and wherein the at least one processor is configured to execute program code instructions to cause the apparatus to perform steps comprising:
capturing a plurality of M captured images of an object through the optical system, wherein each captured image of the plurality of images is captured with the configurable optical component being in a different corresponding configuration of the plurality of configurations;
transforming each of the captured images using a selected spatial transform to obtain a corresponding transformed captured image, whereby a plurality of M transformed captured images result;
weighting each of the transformed captured images by a weighting coefficient Aₘ computed using the formula
$${A}_{m} = \frac{{R}_{m}^{*}}{\frac{{s}_{noise}}{{s}_{obj}} + {\sum }_{m = 1}^{M} {\vert {R}_{m} \vert}^{2}} ,$$
wherein Rₘ is the optical transfer function of the optical system in configuration corresponding to the captured image from which said each of the transformed captured images was obtained, Rₘ* is the complex conjugate of Rₘ, S_{Noise} is the average power spectral density of the noise projection of the object, and S_{Obj} is the average power spectral density of the noise-free projection of the object, resulting in a weighted image corresponding to said transformed captured image, whereby a plurality of M weighted images are obtained;
summing the weighted images of the plurality of M weighted images to obtain a summed transformed image; and
inverse transforming the summed transformed image using inverse transform of the selected spatial transform to obtain a processed image.

22-78. (canceled)
